(19) United States
(12) Patent Application Publication
(10) Pub. No.: US 2021/0123572 A1
(43) Pub. Date: Apr. 29, 2021

(54) ADVERTISING LAMP

(71) Applicant: Xiamen PVTECH Co., Ltd., xiamen (CN)

(72) Inventors: FUXING LU, Xiamen (CN); XIAOPING LAN, Xiamen (CN); WEIBIAO ZHONG, Xiamen (CN)

(21) Appl. No.: 16/851,118

(22) Filed: Apr. 17, 2020

(30) Foreign Application Priority Data
Oct. 24, 2019 (CN) 201911015374.X

(51) Int. Cl. F21K 9/272; F21V 21/005; F21V 23/06; F21V 31/00; F21V 21/104; G09F 13/00

(52) U.S. Cl. CPC F21K 9/272; F21V 21/005; F21V 23/06; F21Y 2115/10; F21V 21/104; G09F 13/00; F21V 31/00

(57) ABSTRACT

An advertising lamp, which including multiple LED lamp tubes. The two ends of each LED lamp tube are respectively provided with a first butt joint and a second butt joint, in which the first butt joint of the LED lamp tube is connected with the second butt joint of another LED lamp tube. At least one mounting tube, which is set between two LED lamp tubes and secures the first and second butt joint of the butt joint, so as to realize multiple assembly and use with power wires.

### BACKGROUND OF THE INVENTION

### 1. Field of the Invention

The invention relates to an advertising lamp, in particular to an advertising lamp which can be longitudinally assembled together.

### 2. Description of the Prior Art

Generally, shop, night market stallholder, dining-room regular uses flowery, ablaze lamplight to build the atmosphere that gives profusion romance. Accordingly, the lamp that has full of beautiful things in eyes on market is acted the role of can choose. The lamp tubes inside the advertisement lamps are all of the same size and specification. When connection of the lamp tubes is required, additional power wires are used as the connector. Since the sizes of the advertisement lamps are different, the lamp tubes cannot be set according to different special sizes. The leads to brightness inequality or dark areas due to unevenly placed lamp tubes.

Therefore, a design for the advertisement lamp that can meet the above utility is an urgent problem for the relevant personnel in this field to improve.

### SUMMARY OF THE INVENTION

In view of the above problems, an embodiment of the invention provides an advertising lamp, which comprises multiple LED lamp tubes. Each LED lamp tube is provided with a first butt joint and a second butt joint, wherein the first butt joint of the LED lamp tube is connected with the second butt joint of another LED lamp tube. At least one mounting tube is arranged between the two LED lamp tubes and mounting to the first and second butt joints.

According to a preferred embodiment of the advertising lamp in accordance with present invention, wherein the mounting tube has multiple hoisting holes.

According to a preferred embodiment of the advertising lamp in accordance with present invention, wherein, a power supply connector is also included, which is connected to the mounting tube.

According to a preferred embodiment of the advertising lamp in accordance with present invention, the power supply connector is a G13 rotating lamp holder or a power wire.

According to a preferred embodiment of the advertising lamp in accordance with present invention, the mounting tube is separately arranged and sleeves that mounted with the first butt joint and the second butt joint of the LED lamp tubes. The first butt joint or the second butt joint may be installed with a power supply connector.

According to a preferred embodiment of the advertising lamp in accordance with present invention, wherein, an R17D rotating lamp holder is provided. The R17D rotating lamp holder is connected to the power supply connector.

According to a preferred embodiment of the advertising lamp in accordance with present invention, the first butt joint is a plug.

According to a preferred embodiment of the advertising lamp in accordance with present invention, the first butt joint is provided with at least one waterproof rubber ring.

According to a preferred embodiment of the advertising lamp in accordance with present invention, the second butt joint is a socket.

According to a preferred embodiment of the advertising lamp in accordance with present invention, the LED lamp tube comprises an aluminum extruded lamp holder, a light source plate arranged on the aluminum extruded lamp holder and a lampshade arranged on the aluminum extruded lamp holder. The light source plate comprises at least one light emitting element and at least one light emitting element facing the lampshade.

According to a preferred embodiment of the advertising lamp, the LED lamp tube emits light from one side or both sides.

In summary, according to one embodiment or more embodiments of the invention, the advertising lamp has the following characteristics, which can realize freely assembly, can be used with power wires, and has the waterproof function. It can also be used with R17D rotating lamp holder after multiple lamp tubes assembly. The whole LED lamp tube can meet any standard length of the lamp tube that required, and be installed in any standard lamp holder.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the three-dimensional appearance of the advertising lamp according to the invention.

FIG. 2 is a schematic diagram of the three-dimensional explosion of the advertising lamp according to the invention.

FIG. 3 is a schematic diagram of the connection of two LED lamp tubes according to the invention.

FIG. 4 is a schematic diagram of a power supply connection connected to an LED lamp tube according to the invention.

FIG. 5 is another schematic diagram of the LED lamp tube connecting a power supply connector according to the invention.

### DETAILED DESCRIPTION

The following detailed in the implement of the detailed features and advantages of this invention, its content is enough to make any familiar with related skills is to understand the technical content of this invention and cultivating, and according to the specifications, the content of disclosure of requirements and schema, any familiar with relevant skills can easily understand the purpose of this creation related and advantages.

In order to explain in detail the technical content, structural characteristics, realized purpose and effect of the technical scheme, the following specific embodiments are combined with the attached drawings for detailed explanation.

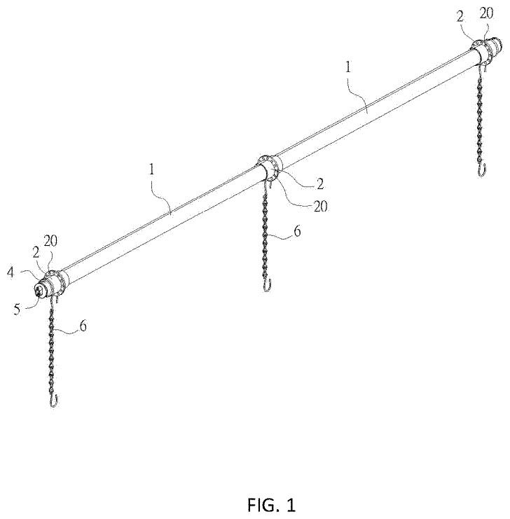

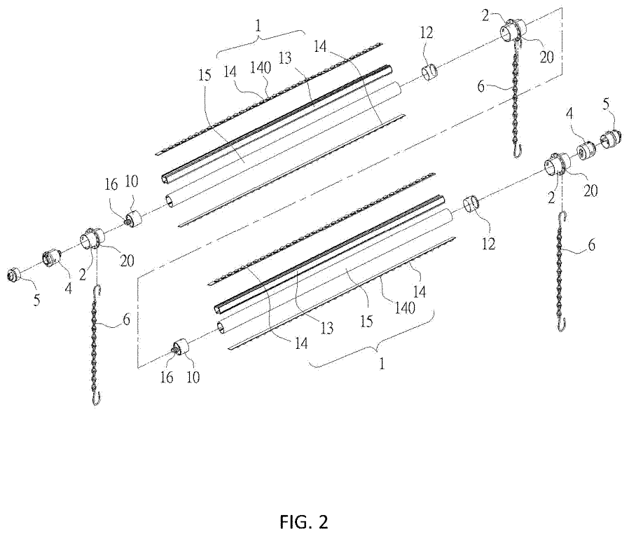

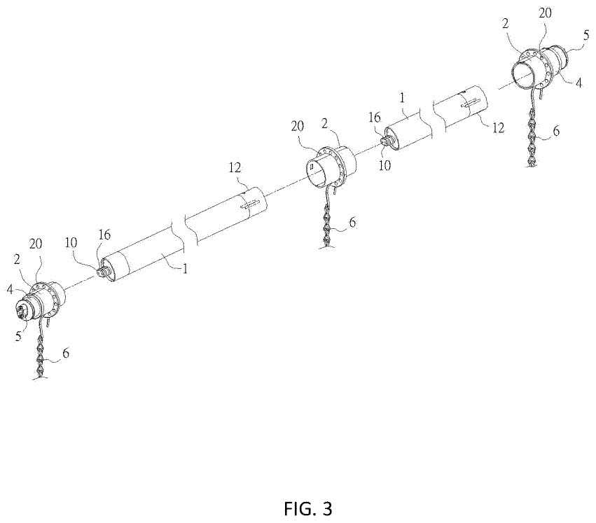

Please refer to FIG. 1, FIG. 2 and FIG. 3 for the schematic diagram of the three-dimensional appearance of the advertising lamp, the schematic diagram of the three-dimensional explosion of the advertising lamp and the schematic diagram of the connection of two LED lamp tubes. The present invention provides an advertising lamp, comprises:

multiple LED lamp tubes 1 and at least one mounting tube 2. Each end of the LED lamp tube has a first butt joint 10 and a second butt joint 12. The first butt joint 10 of the LED lamp tube 1 is connected with the second butt joint 12 of the other LED lamp tube 1. The mounting tube 2 being provided between and mounted with the first butt joint 10 (as a plug) of the LED lamp tube 1 and the second butt joint 12 (as a socket) of the other LED lamp tube 1 respectively. The LED lamp tube 1 emits light from one side or both sides, and may have a lens.

The mounting tube 2 has multiple hoisting holes 20. With the hoisting holes 20, steel bars 6 can be connected to facilitate the installation and adjustment of LED lamp tubes.

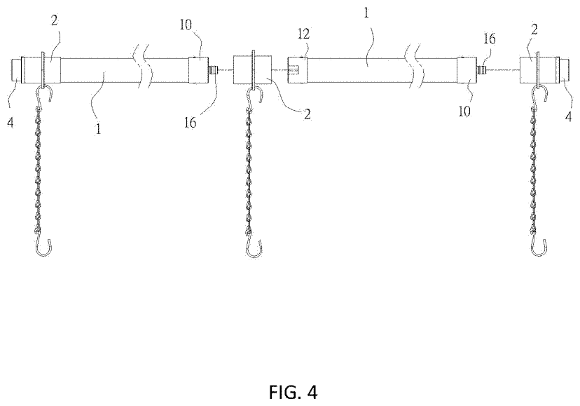

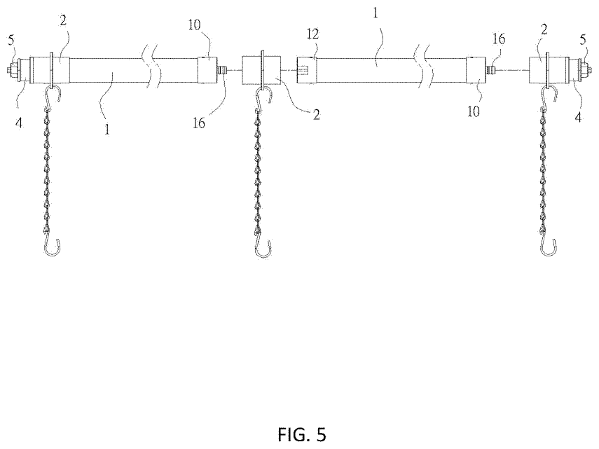

The invention also includes a power supply connector 4, which is connected to the mounting tube 2, and the power supply connector 4 can be a G13 rotating lamp holder or a power wire (see FIG. 4 and FIG. 5).

The invention also includes an R17D rotating lamp holder 5, which is connected to the power supply connector 4.

The first butt joint 10 (as the plug) mentioned above can be equipped with at least one waterproof rubber ring 16, which can be made of silica gel, and the quantity shall not be limited to this.

The LED lamp tube 1 mentioned above has an aluminum extruded lamp holder 13, a light source plate 14 arranged on an aluminum extruded lamp holder 13 and a lampshade 15 arranged on an aluminum extruded lamp holder 13. The light source plate 14 has at least one light emitting element 140 and at least one light emitting element 140 facing the lampshade 15.

The mounting tube 2 in the preceding paragraph is separately arranged in the LED lamp tube 1 and is arranged in the first butt joint 10 and the second butt joint 12 that have the installed power supply connector 4.

Please refer to FIG. 4 and FIG. 5 for the schematic diagram of the LED lamp tube connecting a power supply connector according to the invention and another schematic diagram of the LED lamp tube connecting a power supply connector. In the embodiment in the FIG. 4, when taking two long LED lamp tubes 1 as an example.

When assembling, the mounting tube 2 being mounted with the second butt joint 12 (as a socket) of a LED lamp tube 1, then, the first butt joint 10 (as a plug) of the other LED lamp tube 1 mounts and connects to the second butt joint 12 (as a socket). Such that the mounting tube 2 secures the LED lamp tubes 1. Moreover, the other first butt joint 10 and second butt joint 12 of the LED lamp tubes that not connected may be mounted with other mounting tubes 2 having multiple hoisting holes 20 formed thereon. With the hoisting holes 20, steel bars 6 can be connected to facilitate the installation and adjustment of LED lamp tubes. The power supply connector 4 in this embodiment takes G13 rotating lamp holder as an example. In such way, multiple lamp tubes 1 are easily assembled. The whole LED lamp tube can meet any standard length of the lamp tube that required.

In addition, each LED lamp tube 1 is equipped with at least one waterproof rubber ring 16 at the first butt joint 10 (as the plug), which can be made of silica gel. When the first butt joint 10 equipped with waterproof rubber ring 16 is connected with the second butt joint 12, it can prevent the external water gas or water infiltration resulting in electrical short-circuit hazard.

The other by the embodiment of the FIG. 5, take two LED lamp tubes 1 in the same length for example. When assembling, the mounting tube 2 being mounted with the second butt joint 12 (as a socket) of a LED lamp tube 1, then, the first butt joint 10 (as a plug) of the other LED lamp tube 1 mounts and connects to the second butt joint 12 (as a socket). Such that the mounting tube 2 secures the LED lamp tubes 1. Moreover, the other first butt joint 10 and second butt joint 12 of the LED lamp tubes that not connected may be mounted with other mounting tubes 2 having multiple hoisting holes 20 formed thereon. With the hoisting holes 20, steel bars 6 can be connected to facilitate the installation and adjustment of LED lamp tubes. The power supply connector 4 in this embodiment takes the power wire as an example.

In addition, the R17D rotating lamp holder 5 can be additionally connected to the power connector 4, so as to meet the requirements of the R17D specification, to provide convenience for more forms of connection.

Accordingly, the LED lamp tube 1 with different lengths can freely assembly. It can also be used with R17D rotating lamp holder. The whole LED lamp tube 1 can meet any standard length of the advertising lamp tube that required, and be installed in any standard lamp holder.

In other words, when the standard length requirement of the lamp tube is 1.8 m, multiple LED lamp tube 1 can be connected with the first butt joint 10 and the second butt joint 12 respectively, and then the R17D rotating lamp holder can be installed at both ends respectively. In such way, the length of assembled LED lamp tubes can adjustably meet the standard specification of 1.8 m. When it is necessary to change the length to 2.4 meters, only one more set of LED lamp tube to be added, and after the assembly, the last two ends are also installed with R17D rotating lamp holder. With such, the length of assembled LED lamp tubes meets the standard specification of 2.4 meters.

In addition, each LED lamp tube 1 mentioned above is equipped with at least one waterproof rubber ring 16 at the first butt joint 10 (as the plug), which can be made of silica gel. When the first butt joint 10 equipped with waterproof rubber ring 16 is connected with the second butt joint 12, it can prevent the external water gas or water infiltration resulting in electrical short-circuit hazard.

It should be noted that although the above embodiments have been described in this paper, it does not therefore limit the scope of patent protection of the invention. Based on the concept of innovation of the present invention, therefore, to change and modify of implementation example, or use of the present invention the description and the appended drawings of the equivalent structure or equivalent flow transformation, directly or indirectly, to apply the above technical scheme in other related technical field, are included within the scope of protection of the invention patent.

Those skilled in the art will readily observe that numerous modifications and alterations of the device and method may be made while retaining the teachings of the invention. Accordingly, the above disclosure should be construed as limited only by the metes and bounds of the appended claims.

1. An advertising lamp comprises:
multiple LED lamp tubes, each end of the LED lamp tube having a first butt joint and a second butt joint, wherein the first butt joint of the LED lamp tube is connected with the second butt joint of the other LED lamp tube;
at least one mounting tube being provided between and mounted with the first butt joint of the LED lamp tube and the second butt joint of the other LED lamp tube respectively;
a power supply connector connected to the mounting tube;
an R17D rotating lamp holder connected to the power supply connector; and
at least one waterproof rubber ring;
wherein
the first butt joint is a protruding plug;
the second butt joint is a recessed socket;
the waterproof rubber ring mounted on an outer surface of the first butt joint, when the first butt joint inserted into the second butt joint, the waterproof rubber ring tight fitting with the inner wall of the second butt joint, thus achieving a waterproof effect.

2. The advertising lamp as claimed in claim 1, wherein the mounting tube has multiple hoisting holes.

3. (canceled)

4. The advertising lamp as claimed in claim 31, wherein the power supply connector is a G13 rotating lamp holder or a power wire.

5. The advertising lamp as claimed in claim 4, wherein the mounting tube is attached with the first butt joint and the second butt joint that being installed with the power supply connectors.

6. (canceled)

7. (canceled)

8. (canceled)

9. (canceled)

10. The advertising lamp as claimed in claim 1, wherein the LED lamp tube comprises an aluminum extruded lamp holder, a light source plate arranged on the aluminum extruded lamp holder and a lampshade arranged on the outside of the aluminum extruded lamp holder, and the light source plate comprises at least one light emitting element facing the lampshade.

11. The advertising lamp as claimed in claim 10, wherein the LED lamp tube emits light from one side or both sides.
